(19) United States
(12) Patent Application Publication
(10) Pub. No.: US 2004/0193431 A1
(43) Pub. Date: Sep. 30, 2004

(54) Remote gaming system

(76) Inventor: John Campbell, Cremorne (AU)

Correspondence Address: BOZICEVIC, FIELD & FRANCIS LLP, 200 MIDDLEFIELD RD, SUITE 200, MENLO PARK, CA, 94025, US

(21) Appl. No.: 10/362,137

(22) PCT Filed: Aug. 30, 2001
(86) PCT No.: PCT/AU01/01090

(30) Foreign Application Priority Data
Aug. 30, 2000 (AU) 55007/00

(51) Int. Cl. G06F 17/60

(52) U.S. Cl. 705/1

(57) ABSTRACT

A gaming system (10) is described which includes means (16) for facilitating connection to the gaming system (10) by a user (12) from a remote location, at least one game (24) playable by a user (12) for a monetary stake when the user (12) is connected to the gaming system (10), and means (18) for allocating to each user (12) a monetary commission. Each user (12) is sponsored by another user, and the magnitude of the monetary commission received by each user (12) depends on the gaming activity of other users (12).

### FIELD OF THE INVENTION

The present invention relates to a gaming system of the type which is played by a user from a remote location.

### BACKGROUND OF THE INVENTION

It is known to provide a gaming system which facilitates gaming by a user from a remote location. Such gaming systems are generally implemented in the form of a website which is accessible via the Internet. The gaming system usually operates by receiving credit card details from the user, and by allowing the user to play games such as Poker, Roulette or Blackjack for a stake debited from the users credit card, any winnings from the games being credited to the users credit card. However, a disadvantage of such a gaming system is that unless the user wins whilst playing one of the games, the user is not able to retrieve the lost stake.

### SUMMARY OF THE INVENTION

In accordance with a first aspect of the present invention, there is provided a gaming system including:

means for facilitating connection to the gaming system by a user from a remote location;

at least one game playable by a user for a monetary stake when the user is connected to the gaming system; and

means for allocating to each user a monetary commission;

wherein the magnitude of the monetary commission received by each user depends on the gaming activity of other users.

Preferably, each user is a member of the gaming system and the members are arranged in a tree-like structure.

Preferably, each member is part of an organisation including the member at the head of the organisation and all members in subsequent levels of the tree directly or indirectly associated with the member.

Preferably, the monetary commission received by each member depends on the gaming activity of other members in the members organisation.

Preferably, the gaming system includes a database for storing a plurality of member accounts, each member account being associated with a member.

Preferably, each member account includes a financial account for storing financial information relating to a member. Each member account preferably also includes a profile account for storing demographic and identification information relating to a member.

Preferably, the games include a lottery game, a poker game, a blackjack game and a stocks game.

Preferably, a proportion of the monetary commission for each member is transferred to the financial account associated with the member and a remaining proportion of the monetary commission for each member is used to purchase stocks for the user from the stocks game. The proportion is preferably ⅔.

A proportion of winnings received by each member as a result of playing the games may be transferred to the financial account associated with the member and a remaining proportion of the winnings may be used to purchase stocks for the member from the stocks game. The proportion is preferably ⅔ and, preferably, any winnings arising from playing the lottery game only are in part used to purchase stocks and not winnings arising from playing the poker game or the blackjack game.

Preferably, each member is sponsored by another member and each member is positionable in the tree structure at a position in the sponsoring members organisation which is selectable by the sponsoring member.

Preferably, the means for facilitating connection to the gaming system includes a website accessible by a member through the Internet.

In accordance with a second aspect of the present invention, there is provided a method of gaming, said method including the steps of;

facilitating connection to a gaming system by a user from a remote location;

providing at least one game playable by a user for a monetary stake when the user is connected to the gaming system; and

allocating to each user a monetary commission;

wherein the magnitude of the monetary commission received by each user depends on the gaming activity of other users.

In accordance with a third aspect of the present invention, there is provided a method of gaming, said method including the steps of:

facilitating connection to a gaming system by a user from a remote location;

transferring a request from a user to the gaming system to play at least one game associated with the gaming system for a monetary stake; and

receiving from the gaming system a monetary commission allocated to the user by the gaming system;

wherein the magnitude of the monetary commission received by each user depends on the gaming activity of other users.

In accordance with a fourth aspect of the present invention, there is provided a transmissible data package generated by a gaming system,

said data package being generated in response to a request to play a game from a user, and

said data package including information indicative of a monetary commission allocated to the user by the gaming system, the magnitude of the monetary commission allocated to the user depending on the gaming activity of other users.

### BRIEF DESCRIPTION OF THE DRAWINGS

An embodiment of the present invention will now be described, by way of example only, with reference to the accompanying drawings, in which:.

FIG. 1 is a block diagram of a gaming system in accordance with the present invention shown in relation to a user;

FIG. 2 is a schematic diagram showing the structure of member accounts of the gaming system shown in FIG. 1;

FIG. 3 is a flow diagram showing steps taken for a person to become a member of the gaming system shown in FIG. 1;

FIG. 4 is a flow diagram showing steps taken for a member to receive commission from the gaming system shown in FIG. 1; and

FIG. 5 is a schematic diagram showing positioning of new members in the member account structure shown in FIG. 2.

### DETAILED DESCRIPTION OF AN EMBODIMENT OF THE INVENTION

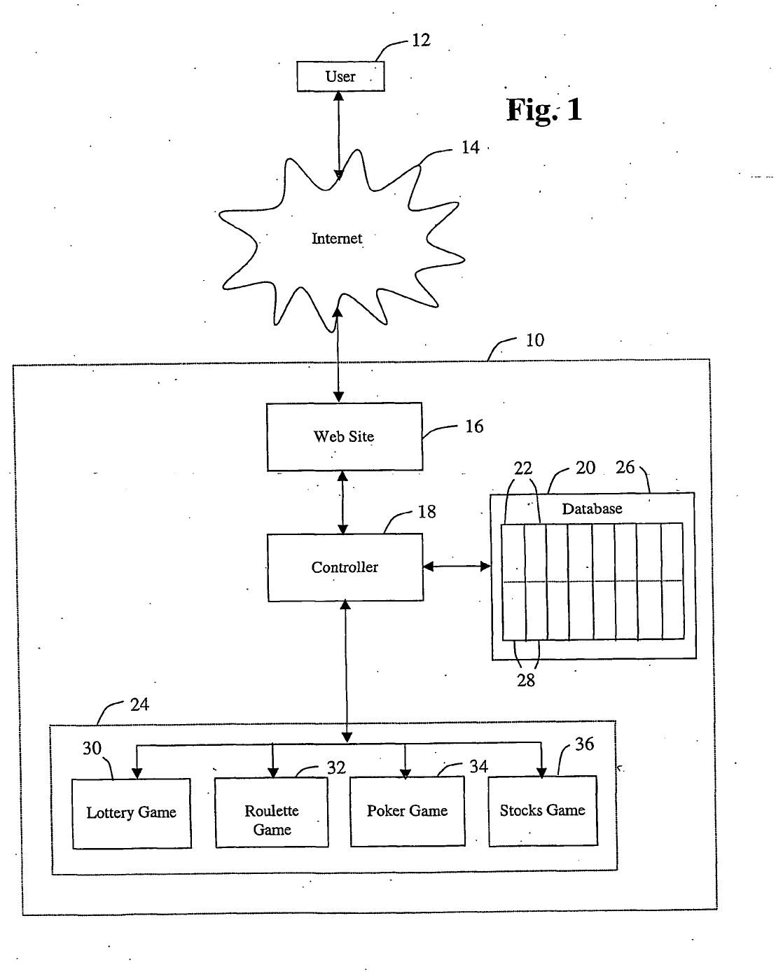

Referring to the drawings, in FIG. 1 there is shown a gaming system 10 accessible by a user 12 through any suitable communications means, in this example through the Internet 14.

The gaming system 10 includes a graphical user interface, in this example in the form of a website 16 which is accessible by the user 12 through the Internet 14, a controller 18, a database 20 for storing a plurality of member accounts 22, and a plurality of games 24 which may be played by the user 12.

The member accounts 22 stored in the database 20 each include a financial account 26 which records financial information relating to the member and a profile account 28 which stores demographic and identification information relating to the member. The financial information of the member may be recorded in “units” with each unit corresponding to an amount of money. For example, one unit may correspond to US$1. The units may be subdivided into “credits” with each credit corresponding to US$10. The demographic information may include the address of the member, and the identification information may be an identification number unique to the member.

The games 24 may include any game which is playable by a member for a monetary stake. In this example, the games 24 may include a lottery game 30, a roulette game 32, a poker game 34 and a stocks game 36.

The lottery game 30 is a game wherein a series of numbers, for example six numbers, are selected by a member or generated at random by the gaming system 10 and a corresponding number of winning numbers are generated at random by the gaming system 10. If the numbers selected by. the member are the same as the winning numbers generated by the gaming system, the member wins and a predetermined monetary amount in units and/or credits is transferred to the member account associated with the member.

The roulette game 32 and the poker game 34 operate in a manner which corresponds to known roulette and poker games. Any winnings received by a member as a result of playing the roulette and poker games are transferred to the member account associated with the member.

The stocks game 36 is a game which is based on shares trading, the price of shares being determined by supply and demand. With this game, a member can choose to buy shares in the hope that the price of the shares will subsequently increase, in which case the member will make a financial gain. However, if the price of the shares subsequently decreases, the member will make a financial loss. The price of shares increases or decreases depending on whether other members are buying shares or whether other members are selling shares.

Communications between the website 16, the database 20 and the games 24 are controlled by the controller 18.

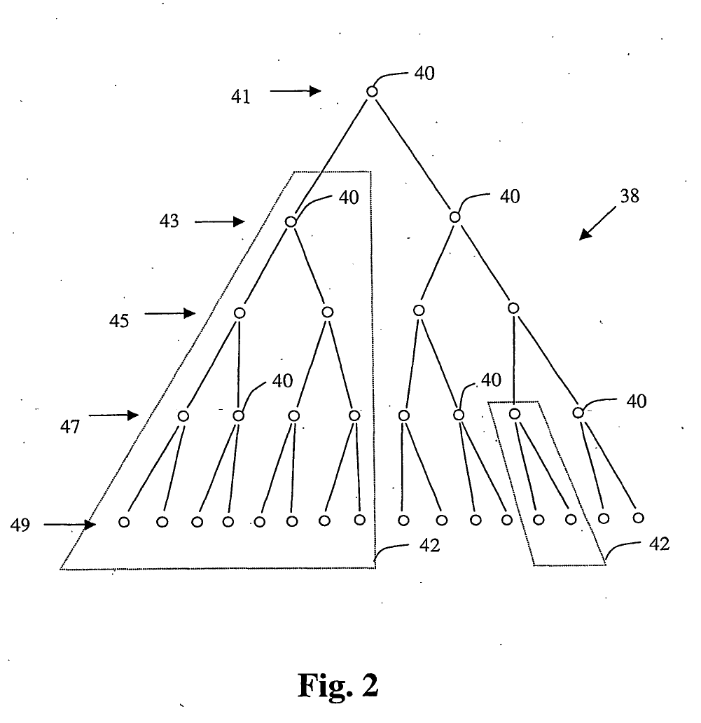

The structure of members associated with the gaming system 10 is shown at 38 in FIG. 2. As can be seen, the structure of members takes the form of a tree having a plurality of levels. First, second, third, fourth and fifth such levels 41, 43, 45, 47, 49 are shown in FIG. 2. A single member 40 is disposed at the first level 41 at the head of the tree and each member 40 has two dependent members disposed directly below the member 40 in a subsequent level in the tree. The combination including a member 40 and all dependent members 40 in subsequent levels directly or indirectly associated with the member 40 is termed an “organisation” 42. Two organisations 42 are indicated in FIG. 2.

It will be understood that each member 40 has an organisation except the members in the lowermost level. These members have no dependent members 40 and, therefore, until new members 40 are added as dependent members, they do not have an organisation.

It will also be understood that each member 40 in the member structure 38 has an associated financial account 26 and an associated profile account 28 stored in the database 20.

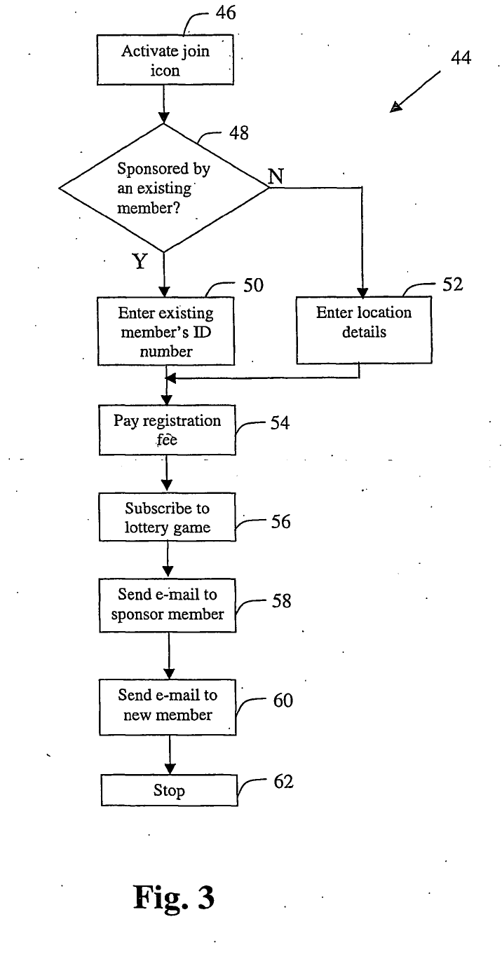

The steps taken by a user to join the gaming system 10 and become a member 40 are shown in the flow diagram 44 in FIG. 3.

Prior to joining the gaming system 10, a user first connects to the website 16 through the Internet 14 for example using any conventional Internet browsing program.

At the home page of the website 16, the user is provided with information about the gaming system 10 and a join icon activatable by the user is displayed. In order to activate the join process, the user activates the join icon for example by using a mouse.

Once the join icon has been activated 46, the user is given the option at 48 of entering the identification number of an existing member. If the user has been given an identification number by an existing member of the gaming system 10, this identification number is entered into the system at step 50. If this occurs, the user is said to be “sponsored” by an existing member. If the user has not been given an identification number by an existing member, the user enters the users location details such as the address of the user, as shown at step 52. The user is then allocated a sponsor in the locality of the user. With both situations the user is given an identification number which is unique to the user. It will be understood that the users identification number and location details are stored in a member account 22 corresponding to the user.

To finalise membership, in this embodiment the user then pays a registration fee as shown at step 54 and subscribes to the lottery game 30 as shown at step 56. The registration fee may be US$25. However, it will be understood that the gaming system may be arranged to finalise membership without the requirement to pay a registration fee or the requirement to subscribe to the lottery game. When all of the above steps have been completed, membership is complete and confirmation e-mails are sent to the sponsoring member and to the new member as shown at steps 58 and 60. The user may also be provided with a login identification and a password which are unique to the user.

The join flow diagram 44 then terminates at step 62.

If the user is already a member of the gaming system 10, the user may connect directly to the games 24 from the home page of the website 16. Preferably, the member is required to enter a login identification and password which are unique to the member and which identify the member.

In a broad sense, the gaming system 10 operates by providing the members 40 of the gaming system 10 with access to a plurality of games 24, each of which may provide the member with a monetary return for a monetary stake, and by providing each member with a monetary commission, the amount of which depends on whether and to what extent other members in the members organisation 42 play the games 24. In other words, even if a member 40 does not win any of the games 24, it is possible for the member 40 to make a monetary gain if other members in the members organisation also play the games 24.

The gaming system 10 is preferably arranged such that to earn commission each member 40 must at least play the lottery game 30 each week. Automatic entry to the lottery game 30 may be incorporated into the joining process for simplicity and may be paid for by the member by either periodical advance payment or direct debit from the. members credit card. For this to occur, it will be understood that the system 10 may be arranged to receive the credit card details, the details being stored in the appropriate profile account 28 associated with the member.

The gaming system 10 is also preferably arranged such that in order to receive commission, each member must sponsor 2 new members per year. The gaming system 10 may forward an e-mail to appropriate members before expiration of the 1 year period if members have not yet sponsored 2 new members in the 1 year period since the last new member was sponsored.

Commission is calculated and paid on a weekly basis. In this example, each commission period commences at 12 am on Monday morning and ends at 12 am the following Monday morning. Commission is paid on a day following each commission period, for example on Friday.

In this embodiment, the gaming system 10 is arranged such that a proportion of winnings from games 24 and a proportion of commission from other members is directed into the stocks game 36. In this way, the value of stocks in the stocks game 36 is encouraged to increase.

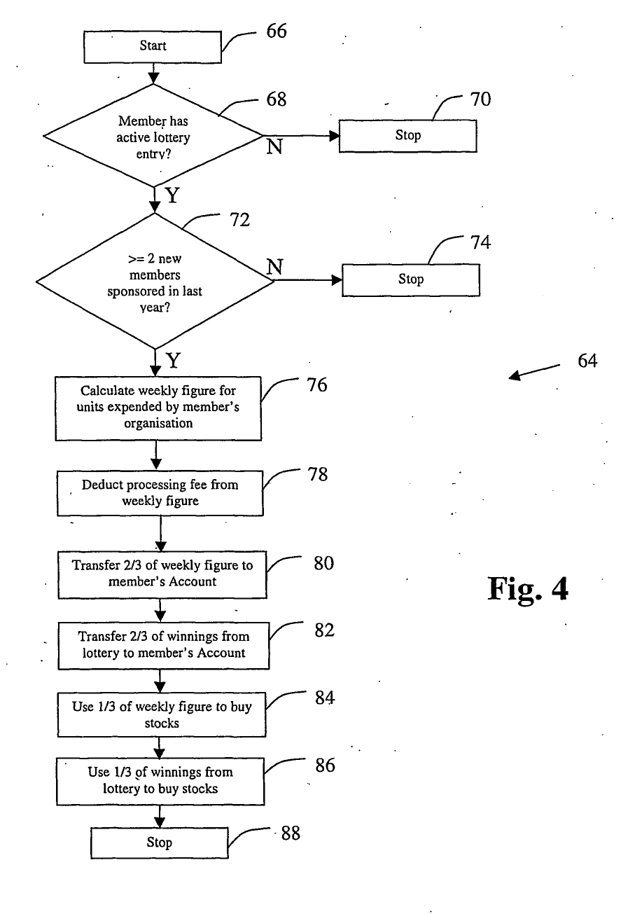

The steps taken by the gaming system 10 for calculating and allocating commission to a member is shown in the flow diagram 64 in FIG. 4.

For each member, at the end of each commission period, the flow diagram 64 is activated and starts at step 66. At steps 68 and 72 the gaming system 10 checks whether the member is entered in the lottery game 30 for the week covered by the commission period, and whether the member has sponsored at least 2 new members in the last year. If either of these conditions is in the negative, the flow diagram stops as indicated at steps 70 and 74 and no commission is allocated to the member. If both of the conditions are in the affirmative, the total amount of units and credits expended on the games 24 by the members organisation is calculated at step 76. This is termed the “weekly sales figure”. A commission processing fee which may be equivalent to US$2 is deducted from the weekly sales figure as indicated at step 78 and the appropriate commission payable to the member is calculated based on the weekly sales figure.

Once the weekly sales figure less processing fee has been calculated, two thirds of the weekly sales figure is allocated to the members account as indicated at step 80 and two thirds of any winnings from the lottery game 30 is allocated to the members account as indicated at step 82. As shown at steps 84 and 86, one third of the weekly sales figure and one third of winnings from the lottery game 30 are used to buy stocks from the stocks game 36 and allocated to the member. It will be understood that any stocks which are allocated to a member are recorded as such in the members account 22. Once stocks have been purchased and allocated to the member, the flow diagram 64 stops as indicated at step 88.

The gaming system is preferably arranged such that should the member not personally allocate the required proportion of the weekly sales figure and the winnings to the purchase of stocks within a predetermined period, such as 5 days from calculation of the weekly figure of winnings, the gaming system automatically purchases stocks for the member and allocates the purchased stocks to the member in the members account 22.

It will be understood that the steps of the flow diagram are carried out for each member 40 of the gaming system 10.

It will also be understood that the more units are expended on the games by the members organisation, the greater the weekly sales figure for the member will be and the greater the commission (in both units and stocks) which is allocated to the member.

All member stock purchases made from commissions or from lottery winnings will be subject to the escrow rule. The escrow rule means that 50% of these purchases are unable to be sold for 3 months from the date of purchase.

Each member has their own secure, password protected area to view their stock holdings and track their performances. This area may be accessible via the website 16.

The weekly sales figure may be calculated as follows.

Each time a members organisation completes 1000 units in one week with at least ⅓ of the 1000 units on the lesser side of the organisation, a cycle has been completed and the member will earn a maximum of US$360. Upon completion of a cycle, all units that were not used to complete the cycle are used in calculating the next cycle.

For example, assume that at the end of a particular commission period a members organisation has totalled 1204 units, made up of 820 units on one side of the organisation and 384 units on the other side of the organisation. After 666 (⅔) units are deducted from the former side and a further 334 units deducted from the latter side, the member will be paid for a full cycle. The remaining 154 units in the former side and the 50 units in the latter side are carried forward as credits to be added to the following week's calculation for the next cycle.

There is no limit to the number of cycles a member can be paid for each week. However, the maximum amount a member can earn each week is US$20,000 with this sum being termed the maximum reward.

The following chart demonstrates the “trigger levels” that generate commission for a member. As will be seen, each cycle is divided into six steps.

| | | Accumulated | Commission |
|---|---|---|---|
| Steps | Units | Units | Each Step $ |
| 1 | 180 | 180 | 60 |
| 2 | 180 | 360 | 30 |
| 3 | 180 | 540 | 30 |
| 4 | 180 | 720 | 60 |
| 5 | 180 | 900 | 60 |
| 6 | 100 | 1000 | 120 |
| Totals | 1000 | 1000 | 360 |

The maximum commission the gaming system will allocate to a member each week is limited to the available pool for each week. This entire pool will be distributed each week. As unit accumulation rates must differ from member to member and week to week this can only mean that qualification for each step and cycle must vary and, in turn, this will lead to cycle payout rates fluctuating each week.

Each member can concurrently “win” units from the game in the following ways:

1. Personally playing the games 24

2. Referring others to the gaming system 10 who, in turn, play the games 24.

Members are neither restricted in the number of games they may play, nor in the number of new members they can sponsor into the gaming system 10. As all members have only two sponsoring positions in the subsequent level directly below them, any more sponsored members must tumble down or “overflow” into the next level below the subsequent level. All units expended on the games 24 by these “overflow” members are taken into account in calculating the commission of all members above the overflow members if the overflow members are in the members organisation 42.

When a member has personally sponsored two members and so filled the only two positions directly below the member, any additional members sponsored by the member can only be positioned on the next level down in any of the available empty positions. The member has the choice of placing these new members in any available position in the next level.

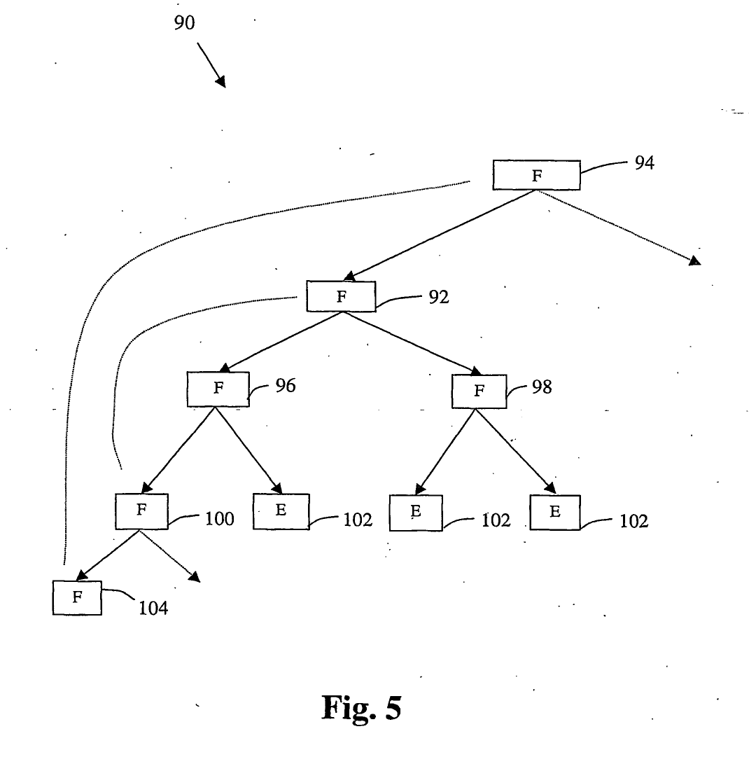

The schematic diagram 90 in FIG. 5 illustrates “overflow”. Positions in the diagram which are occupied by members 40 are indicated by “F”. Positions in the diagram which are not occupied by a member 40 are indicated by “E”.

In the schematic diagram 90, a member 92 has sponsored 2 members 96, 98. If a new member is sponsored by the member 92, the new member may be placed at 100 on the line directly below the sponsored member 96. It will be understood, however, that it would have been possible to place this new member in any of the remaining 3 empty positions 102 since these positions are part of the organisation of the member 92.

Another member 94 has also sponsored a new member and has chosen to position the new member at position 104. This member could also have been placed in any of the empty positions 102. All units generated by new member 104 will accrue to the members 92, 94, 96 and 100.

The gaming system 10 may be arranged such that each member may only have a maximum of three positions within the member tree structure 38. The gaming system 10 may also be arranged such that positions owned by members may be transferred to other members.

The gaming system may also be arranged to facilitate trading of stocks in the stocks game between members. A transaction fee, for example 2% of all transactions, may be levied by the gaming system.

Modifications and variations as would be apparent to a skilled addressee are deemed to be within the scope of the present invention.

1. A gaming system comprising:
means for facilitating connection to the gaming system by a user from a remote location;
at least one game playable by a user for a monetary stake when the user is connected to the gaming system; and
means for allocating to each user a monetary commission;
wherein the magnitude of the monetary commission received by each user depends on the gaming activity of other users.

2. A gaming system as claimed in claim 1, wherein each user is a member of the gaming system and the members are arranged in a tree-like structure.

3. A gaming system as claimed in claim 2, wherein each member is part of an organization comprising the member at the head of the organization and all members in subsequent levels of the tree directly or indirectly associated with the member.

4. A gaming system as claimed in claim 3, wherein the monetary commission received by each member depends on the gaming activity of other members in the members organization.

5. A gaming system as claimed in claim 2, further comprising a database for storing a plurality of member accounts, each member account being associated with a member.

6. A gaming system as claimed in claim 5, wherein each member account includes a financial account for storing financial information relating to a member.

7. A gaming system as claimed in claim 5, wherein each member account includes a profile account for storing demographic and/or identification information relating to a member.

8. A gaming system as claimed in claim 2, wherein the at least one game includes a stocks game.

9. A gaming system as claimed in claim 8, wherein a proportion of the monetary commission for each member is transferred to the financial account associated with the member and a remaining proportion of the monetary commission for each member is used to purchase stocks for the user from the stocks game.

10. A gaming system as claimed in claim 9, wherein the proportion of the monetary commission used to purchase stocks from the stocks game is ⅔.

11. A gaming system as claimed in claims 8, wherein a proportion of winnings received by each member as a result of playing the at least one game is transferred to the financial account associated with the member and a remaining proportion of the winnings is used to purchase stocks for the user from the stocks game.

12. A gaming system as claimed in claim 11, wherein the proportion of the winnings used to purchase stocks is ⅔.

13. A gaming system as claimed in claim 1, wherein the at least one game includes a lottery game, a poker game and/or a blackjack game.

14. A gaming system as claimed in claim 2, wherein each member is sponsored by another member and each member is positionable in the tree structure at a position in the sponsoring member's organization which is selectable by the sponsoring member.

15. A gaming system as claimed in claim 1, wherein the means for facilitating connection to the gaming system includes a website accessible through the Internet.

16. A method of gaming, said method comprising the steps of:
facilitating connection to the gaming system by a user from a remote location;
providing at least one game playable by a user for a monetary stake when the user is connected to the gaming system; and
allocating to each user a monetary commission;
wherein the magnitude of the monetary commission received by each user depends on the gaming activity of each user.

17. A method as claimed in claim 16, wherein each user is a member of the gaming system and the method further includes the step of arranging the members in a tree-like structure.

18. A method as claimed in claim 17, wherein each member is part of an organization including the member at the head of the organization and all members in subsequent levels of the tree directly or indirectly associated with the member.

19. A method as claimed in claim 18, further comprising the step of allocating the monetary commission on the basis of gaming activity of other members in the members organization.

20. A method as claimed in claim 17, further comprising the step of providing a database for storing a plurality of member accounts, each member account being associated with a member.

21. A method as claimed in claim 20, wherein each member account includes a financial account for storing financial information relating to a member.

22. A method as claimed in claim 20, wherein each member account includes a profile account for storing demographic or identification information relating to a member.

23. A method as claimed in claim 17, wherein the at least one game is a stocks game.

24. A method as claimed in claim 23, further comprising the steps of transferring a proportion of the monetary commission for each member to the financial account associated with the member, and using a remaining proportion of the monetary commission for each member to purchase stocks for the member from the stocks game.

25. A method as claimed in claim 24, wherein the proportion of the monetary commission transferred to the financial account associated with the member is ⅔.

26. A method as claimed in claim 23, further comprising the steps of transferring a proportion of winnings received by each member as a result of playing the at least one game to the financial account associated with the member, and using a remaining proportion of the winnings to purchase stocks for the user from the stocks game.

27. A method as claimed in claim 26, wherein the proportion of winnings is transferred to the financial account associated with the member is ⅔.

28. A method as claimed in claim 16, wherein said at least one game includes a lottery game, a poker game and/or a blackjack game.

29. A method as claimed in claim 17, wherein each member is sponsored by another member and the method further includes the step of positioning each sponsored member in the tree structure at a position in the sponsoring members organization which is selectable by the sponsoring member.

30. A method as claimed in claim 16, wherein the step of facilitating connection to a gaming system includes the step of facilitating connection to a website through the internet.

31. A method of gaming, said method comprising the steps of:
facilitating connection to a gaming system by a user from a remote location;
transferring a request from a user to the gaming system to play at least one game associated with the gaming system for a monetary stake; and
receiving from the gaming system a monetary commission allocated to the user by the gaming system;
wherein the magnitude of the monetary commission received by each user depends on the gaming activity of other users.

32. A transmissible data package generated by a gaming system according to claim 1, said data package being generated in response to a request to play a game from a user, and said data package comprising information indicative of a monetary commission allocated to the user by the gaming system, the magnitude of the monetary commission allocated to the user depending on the gaming activity of other users.
